(19) United States
(12) Patent Application Publication
(10) Pub. No.: US 2002/0026667 A1
(43) Pub. Date: Mar. 7, 2002

(54) Lifting aid

(76) Inventor: Timothy A. Berry, Marmet, WV (US)

Correspondence Address: STEPTOE & JOHNSON PLLC, Bank One Center, Sixth Floor, P.O. Box 2190, Clarksburg, WV, 26302-2190, US

(21) Appl. No.: 09/944,916

(22) Filed: Aug. 31, 2001

Related U.S. Application Data
(60) Provisional application No. 60/230,062, filed on Sep. 1, 2000.

(51) Int. Cl. A61G 7/10

(52) U.S. Cl. 5/83.1

(57) ABSTRACT

A manual lifting aid for assisting persons up from a seated or lying position is disclosed, where the lifting aid has a seat portion and a lifting strap. The lifting strap is attached to the bottom of the seat portion such that it extends the entire length of the seat portion and the ends of the lifting strap extend beyond the tapered ends of the seat portion. The lifting aid is used by positioning the seat portion under the buttocks of the person to be lifted, grasping the handles at the ends of the lifting strap, and exerting upward pressure by pulling up on the handles. The lifting strap is of a sufficient length that it permits the user(s) to stand erect, or nearly erect, at the time they exert upward pressure to raise the person or object to be lifted. Stress on the lower back is therefore reduced because the user(s) no longer have to bend at the waist while trying to lift upward.

### CROSS-REFERENCE TO RELATED APPLICATIONS

This application claims priority from U.S. provisional application No. 60/230,062 filed Sep. 1, 2000.

### BACKGROUND OF THE INVENTION

1. Field of the Invention

This invention relates to lifting aids, and more particularly to a portable lifting aid for assisting patients from a lying or seated position.

2. Related Art

Lifting and moving individuals with limited mobility is a task performed many times each day by healthcare professionals. Unfortunately workers often perform this task improperly by bending at the waist, placing their hands and arms under the individual, and lifting with their arms and back. As a result, thousands of healthcare professionals each year either miss work due to injury or work in pain.

Mechanical lifting aids are often used in healthcare facilities to take the physical strain off of healthcare providers in an effort to prevent injuries during lifting. While enjoying modest success in institutional settings, e.g., hospitals and nursing homes, these mechanical devices are not easily transportable, and therefore cannot be used away from the institution. Emergency personnel, such as emergency medical technicians (EMTs) and firefighters, often must provide assistance to people in remote locations, e.g., inside a person's residence or at the sight of an accident. It is not practical for these emergency personnel to transport a large mechanical lifting device with them when called to assist someone in distress. In addition, many fire departments and emergency medical services cannot afford to purchase and maintain expensive mechanical lifting devices. Therefore, there is a need for an inexpensive and portable manual lifting aid that can be used by emergency personnel to lift and transport patients safely.

There have been several attempts to design a portable support or lifting device, but each of these prior devices has disadvantages. In U.S. Pat. No. 954,840 to Wiedemann, a travel carrier or bag is disclosed having a pair of handles which may be grasped by two persons, one on each side, to carry a person seated on the unfolded, main body portion of the carrier. Also, as an improvement of the Wiedemann carrier, U.S. Pat. No. 4,944,057 to Shaw discloses a support and lifting device having two different sets of handles: a pair of flexible handles that can be used in either long or short positions, and a pair of rigid handles. The Shaw carrier also provides an elongated opening in the main body portion to permit the use of toilet facilities by a person seated on the carrier.

Both of these prior art carriers have the same disadvantages when being used to assist in the lifting and carrying of a person. First, the main body portion of the carriers is too large and too wide to be of practical use in an emergency situation. When needing to move a person quickly, it takes too much time and effort to position the entire main body portion of these carriers under the person being moved. There is a lot of sliding and adjustment to properly position the person to ensure that the person is not too close to the edge and that the center of the main body portion is centered under the person. As a result, the extra material of the main body portion often become bunched up and gathered, thereby requiring constant adjustment. Therefore, there is a need for a lifting aid that is narrow enough to easily and quickly slide into proper position underneath a person being lifted.

Second, the handles in each of these carriers are simply attached to the sides of the main body portion. There is no means for reinforcing or securing the handles to the main body portion to prevent the handles from separating or tearing away from the main body portion. In use, if a heavy person is being lifted and transported using a prior art carrier, there is a strong possibility that the weight of the person will force the handles to separate from the main body portion of the carrier, causing the person to be dropped and further injured. Therefore, there is a need for a lifting aid having handles that are reinforced or otherwise secured to the main body portion in a manner that prevents the handles from separating from the main body portion.

Third, these prior art carriers are large and bulky such that they are heavy and cumbersome to carry and to store until needed. Therefore, there is a need for a light-weight lifting aid that is easy to store and transport.

### SUMMARY OF INVENTION

The present invention solves the problems encountered with using mechanical lifting aids by providing a lightweight, portable lifting aid that can be used anywhere to assist in lifting people or objects.

An aspect of the invention is a lifting aid, including a seat portion having a body portion, a first end, a second end, a top side, and a bottom side, and a lifting strap being one piece and having a first end and a second end. The lifting strap is attached to the seat portion such that it extends the entire length of the seat portion and the first end of the lifting strap extends beyond the first end of the seat portion and the second end of the lifting strap extends beyond the second end of the seat portion.

Another aspect of the invention is a method for lifting a person from a seated or lying position using a lifting aid comprising a seat portion having a body portion, a first end, a second end, a top side, and a bottom side, and a lifting strap being one piece having a first end and a second end, wherein the lifting strap is attached to the seat portion such that it extends the entire length of the seat portion and the first end of the lifting strap extends beyond the first end of the seat portion and the second end of the lifting strap extends beyond the second end of the seat portion. The method for lifting includes the steps of: (a) positioning the seat portion of the lifting aid under a patient's buttocks; (b) grasping the first and second ends of the lifting strap; and (c) applying upwards pressure to the first and second ends of the lifting strap.

The invention is useful because it helps prevent injuries to healthcare providers, including emergency personnel, by allowing them to lift and transport patients without straining their lower backs.

A feature of the invention is a seat portion designed to fit comfortably under a patient's buttocks.

Another feature of the invention is a lifting strap, attached to and extending the entire length of and beyond the bottom side of the seat portion of the lifting aid.

Another feature of the invention is loop handles in the first and second ends of the lifting strap to make grasping the lifting aid easier.

An advantage of the invention is that it allows users to lift objects while remaining in an erect, or nearly erect, position as opposed to bending at the waist or knees, thereby preventing back injuries.

Another advantage of the invention is that it is inexpensive to manufacture.

Another advantage of the invention is that it is lightweight and portable.

### BRIEF DESCRIPTION OF FIGURES

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 is a planar bottom view of the lifting aid of the present invention.

FIG. 2 is a planar top view of the lifting aid.

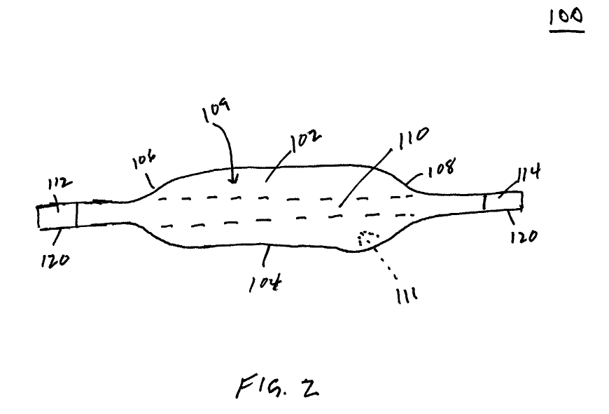

FIG. 3 is a perspective view of the lifting aid in use.

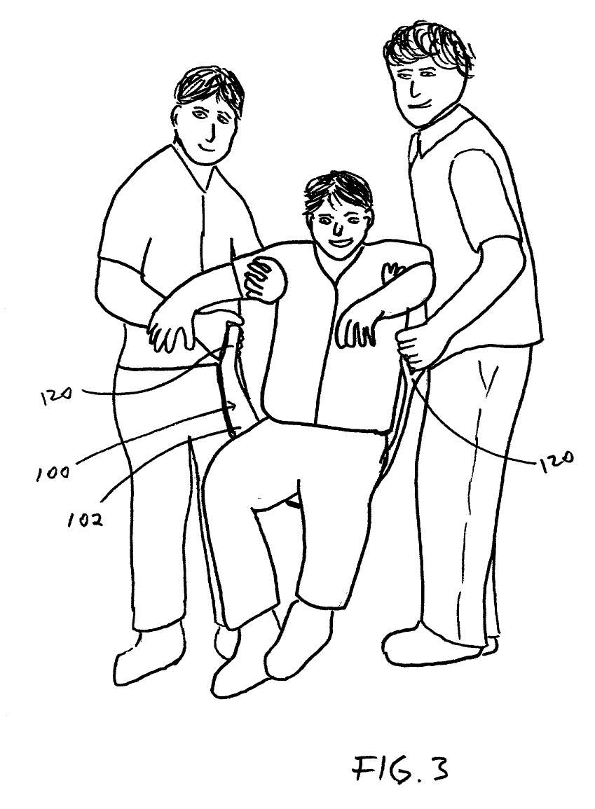

### Detailed Description of the Preferred Embodiments

The present invention is described in relation to lifting a person (or patient) for convenience purposes only. Alternative embodiments in which the invention is used for lifting other objects are within the intended scope of this invention.

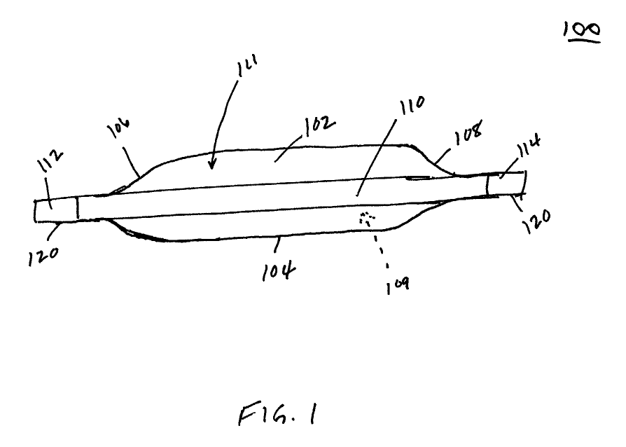

Referring to FIG. 1, the lifting aid 100 of the present invention includes a seat portion 102 having a body portion 104, a first end 106, a second end 108, a top side 111, and a bottom side 109. A lifting strap 110, being one piece having a first end 112 and a second end 114, is attached to the seat portion 102 of the lifting aid 100 such that the lifting strap 110 extends the entire length of and beyond the ends of the seat portion 102. The lifting strap 110 is preferably attached along a longitudinal center axis to the bottom side 109 of the seat portion 102, but can alternatively be attached to the top side 111 of the seat portion 102. The preferred means for attaching the lifting strap 110 to the seat portion 102 is by three rows of continuous stitching about ¾″ apart and extending along the entire length of the seat portion 102. Nonlimiting examples of alternative means for attaching include loops, buckles, glue, staples, zippers, snaps, rivets, and velcro.

In a preferred embodiment, the lifting strap 110 is attached to the bottom side 109 of the seat portion 102 such that the first end 112 of the lifting strap 110 extends beyond the first end 106 of the seat portion 102 and the second end 114 of the lifting strap 110 extends beyond the second end 108 of the seat portion 102. The first end 112 and the second end 114 of the lifting strap 110 preferably comprise handles 120 for grasping the lifting aid 100 during use. The handles 120 are preferably made by folding the first end 112 and second end 114 back onto the lifting strap 110 thereby forming loops. The first end 112 and second end 114 are then secured to the underlying lifting strap 110, preferably by sewing the edges of the first end 112 and second end 114 to the underlying lifting strap 110. However, the first end 112 and second end 114 can be secured by alternative means, such as but not limited to loops, buckles, glue, staples, zippers, snaps, rivets, or velcro. The handles 120 are preferably about 6 inches in length to ensure that a person's hand can fit through the loops, but can be made of any appropriate length.

The lifting aid 100 of the present invention is used by positioning the seat portion 102 under the buttocks of the person to be lifted. An acceptable seat portion 102 must provide sufficient strength to support the weight of the person to be lifted, as well as possess sufficient flexibility such that the seat portion 102 is maneuverable and tends to conform to the person under which it is situated. Additionally, the seat portion 102 should be of a sufficient width and length that the person being lifted can be balanced on the seat portion 102 with minimal additional assistance. The seat portion 102 is preferably made of vinyl covered canvas material, but can alternatively be made of leather, rubber, plastic, or various other materials possessing the desired strength, flexibility, and durability characteristics. While the size of the seat portion 102 can be varied depending on the size of the person to be lifted, e.g, depending on whether you are lifting a child or an adult, the seat portion 102 is preferably about 40″ long and 6″ wide along its body 104. The seat portion 102 optionally, and preferably tapers at its first end 106 and second end 108 to a width of about 2″. In other embodiments, the seat portion 102 has a length within the range of 32″ to 48″ and a width within the range of 4″ to 8″.

The lifting strap 110 of the present invention must be sufficiently strong to support the weight of the person being lifted. The lifting strap 110 should also be long enough to allow the user(s) to stand upright, or nearly upright, while lifting to alleviate any strain on a persons arms and back. Also, the lifting strap 110 should be of the proper width and material to allow the user(s) to easily grasp and hold the lifting strap 110. The lifting strap 110 is preferably made of nylon material much like that used to make automobile safety belts. However, the lifting strap 110 can be made of various alternative materials having sufficient strength, flexibility, and durability characteristics, such as but not limited to rope, chain, or leather. While the length of the lifting strap 110 can be varied depending on the size of the user and the object to be lifted, the lifting strap 110 is preferably about 52″ long including the handles 200 and has a width of about 2″. In other embodiments, the lifting strap 110 has a length within the range of 46″ to 60″ and a width within the range of 1″ to 3″. Accordingly, in the preferred embodiment, the length of the seat portion is about 75-80 percent of the length of the lifting strap.

### CONCLUSION

While various embodiments of the present invention have been described above, it should be under-stood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is claimed is:

1. A lifting aid, comprising:
a seat portion having a body portion, a first end, a second end, a top side, a bottom side, and a length;
a lifting strap being one piece having a first end and a second end, wherein said lifting strap is attached to said seat portion such that said lifting strap extends the length of said seat portion, said first end of said lifting strap extends beyond said first end of said seat portion, and said second end of said lifting strap extends beyond said second end of said seat portion; and
a means for attaching said lifting strap to said seat portion.

2. The lifting aid according to claim 1, wherein said means for attaching is selected from group consisting of: stitches, loops, buckles, glue, staples, zippers, snaps, and velcro.

3. The lifting aid according to claim 1, wherein said lifting strap is attached to said bottom side of said seat portion.

4. The lifting aid according to claim 1, wherein said first end and said second end of said lifting strap further comprise a handle for grasping said lifting aid.

5. The lifting aid according to claim 4, wherein said handles are loops.

6. The lifting aid according to claim 5, wherein said loops are made by folding said first end and said second end of said lifting strap back such that said first end and said second end overlap said lifting strap, and sewing said first end and said second end to said lifting strap.

7. The lifting aid according to claim 6, wherein said loops are about 6 inches in length.

8. The lifting aid according to claim 1, wherein said lifting strap is about 52 inches long.

9. The lifting aid according to claim 9, wherein said lifting strap is about 2 inches wide.

10. The lifting aid according to claim 1, wherein the length of said seat portion is about 75-80 percent of the length of said lifting strap.

11. The lifting aid according to claim 1, wherein said lifting strap is made of nylon.

12. The lifting aid according to claim 1, wherein said body portion of said seat portion is generally rectangular in shape.

13. The lifting aid according to claim 12, wherein said first end and said second end of said seat portion taper in width such that said first end and said second end of said seat portion are approximately equivalent in width to said lifting strap.

14. The lifting aid according to claim 1, wherein said seat portion is made of canvas.

15. The lifting aid according to claim 14, wherein said canvas seat portion is covered with vinyl.

16. The lifting aid according to claim 1, wherein said body portion of seat portion is about 6 inches wide.

17. The lifting aid according to claim 1, wherein said seat portion is about 40 inches long.

18. The lifting aid according to claim 1, wherein the length of said seat portion is within the range of about 32″ to 48″, the width of said seat portion is within the range of about 4″ to 8″, the length of said lifting strap is within the range of about 46″ to 60″, and the width of said lifting strap is within the range of about 1″ to 3″.

19. The lifting aid according to claim 1, wherein said lifting strap is centered along a longitudinal axis of said seat portion.

20. A method for lifting a person from a seated or lying position using a lifting aid, comprising the steps of:
a. positioning a seat portion of a lifting aid under a patient's buttocks, said lifting aid having said seat portion having a body portion, a first end, a second end, a top side, a bottom side, a length, and a width, a lifting strap having a first end, a second end, a length, and a width, wherein said lifting strap is attached to said seat portion such that said lifting strap extends the length of said seat portion, said first end of said lifting strap extends beyond said first end of said seat portion, and said second end of said lifting strap extends beyond said second end of said seat portion;
b. grasping said first and second ends of said lifting strap; and
c. applying upwards pressure to said first and second ends of said lifting strap.
